(19) United States
(12) Patent Application Publication
(10) Pub. No.: US 2019/0114594 A1
(43) Pub. Date: Apr. 18, 2019

(54) ATTENDANCE STATUS MANAGEMENT APPARATUS, ATTENDANCE STATUS MANAGEMENT METHOD, AND NON-TRANSITORY COMPUTER READABLE MEDIUM STORING ATTENDANCE STATUS MANAGEMENT PROGRAM

(71) Applicant: FUJI XEROX CO., LTD., Tokyo (JP)

(72) Inventors: Jo SUDA, Kanagawa (JP); Fumitaka KIKAWADA, Kanagawa (JP)

(73) Assignee: FUJI XEROX CO., LTD., Tokyo (JP)

(21) Appl. No.: 16/153,846

(22) Filed: Oct. 8, 2018

(30) Foreign Application Priority Data
Oct. 18, 2017 (JP) 2017-201673

(51) Int. Cl. G06Q 10/10; H04W 4/021; G06F 21/32

(52) U.S. Cl. CPC G06Q 10/1091; G06F 21/32; H04W 4/021

(57) ABSTRACT

An attendance status management apparatus includes a determination unit and a management unit. The determination unit determines whether or not a position of a sub terminal device is a position within a predetermined distance from a main terminal device, and determines whether or not a position of the sub terminal device is a position within an area which is an attendance target. The management unit manages an attendance status of an owner of the sub terminal device, based on a determination result of the determination unit.

### CROSS-REFERENCE TO RELATED APPLICATIONS

This application is based on and claims priority under 35 USC 119 from Japanese Patent Application No. 2017-201673 filed Oct. 18, 2017.

### BACKGROUND

### Technical Field

The present invention relates to an attendance status management apparatus, an attendance status management method, and a non-transitory computer readable medium storing an attendance status management program.

### SUMMARY

According to an aspect of the invention, there is provided an attendance status management apparatus including a determination unit that determines whether or not a position of a sub terminal device is a position within a predetermined distance from a main terminal device, and determines whether or not a position of the sub terminal device is a position within an area which is an attendance target; and a management unit that manages an attendance status of an owner of the sub terminal device, based on a determination result of the determination unit.

### BRIEF DESCRIPTION OF THE DRAWINGS

Exemplary embodiment(s) of the present invention will be described in detail based on the following figures, wherein:

FIG. 1 is a configuration diagram schematically showing an example of an overall configuration of an attendance status management system according to a first exemplary embodiment;

FIG. 2 is a block diagram showing an example of a configuration of a server, a teacher terminal, and a student terminal according to the first exemplary embodiment;

FIG. 3 is a block diagram showing functions of the server according to the first exemplary embodiment;

FIG. 4 is a diagram showing an example of classroom master data of the first exemplary embodiment;

FIG. 5 is a diagram showing an example of class master data of the first exemplary embodiment;

FIG. 6 is a diagram showing an example of beacon master data of the first exemplary embodiment;

FIG. 7 is a diagram showing an example of student master data of the first exemplary embodiment;

FIG. 8 is a diagram showing an example of course master data of the first exemplary embodiment;

FIG. 9 is a diagram showing an example of classroom transcript data of the first exemplary embodiment;

FIG. 10 is a diagram showing an example of course transcript data of the first exemplary embodiment;

FIG. 11 is a time chart showing an example of operations of the server, the teacher terminal, and the student terminal from the start to the end of a class;

FIG. 12 is a flowchart showing an example of a flow of a teacher terminal process executed by the teacher terminal of the first exemplary embodiment;

FIG. 13 is a flowchart showing an example of a flow of a student terminal process executed by the student terminal of the first exemplary embodiment;

FIG. 14 is a flowchart showing an example of a flow of an attendance status management process executed by the server of the first exemplary embodiment;

FIG. 15 is a block diagram showing an example of a configuration of a server, a teacher terminal, and a student terminal according to a second exemplary embodiment;

FIG. 16 is a block diagram showing functions of a server according to the second exemplary embodiment;

FIG. 17 is a diagram showing an example of a personal page displaying personal information of a teacher;

FIG. 18 is a diagram showing an example of a personal page displaying personal information of a student;

FIG. 19 is a flowchart showing an example of a flow of an attendance status display control process executed by the server according to the second exemplary embodiment;

FIG. 20 is a diagram showing an example of course information according to the second exemplary embodiment;

FIG. 21 is a diagram showing an example of attendance rate information according to the second exemplary embodiment;

FIG. 22 is a diagram showing an example of class information according to the second exemplary embodiment;

FIG. 23 is a diagram showing an example of participation rate information according to the second exemplary embodiment;

FIG. 24 is a time chart showing another example of operations of the server, the teacher terminal, and the student terminal from the start to the end of a class;

FIG. 25 is a time chart showing still another example of operations of the server, the teacher terminal, and the student terminal from the start to the end of a class; and

FIG. 26 is a configuration diagram schematically showing another example of an overall configuration of an attendance status management system according to a first exemplary embodiment.

### DETAILED DESCRIPTION

Hereinafter, exemplary embodiments of the present invention will be described in detail with reference to the accompanying drawings.

### First Exemplary Embodiment

First, the overall configuration of an attendance status management system of the present exemplary embodiment will be described. As a specific example, in the present exemplary embodiment, a case where the attendance status management system manages attendance status of a student taking a class conducted by a teacher at a university.

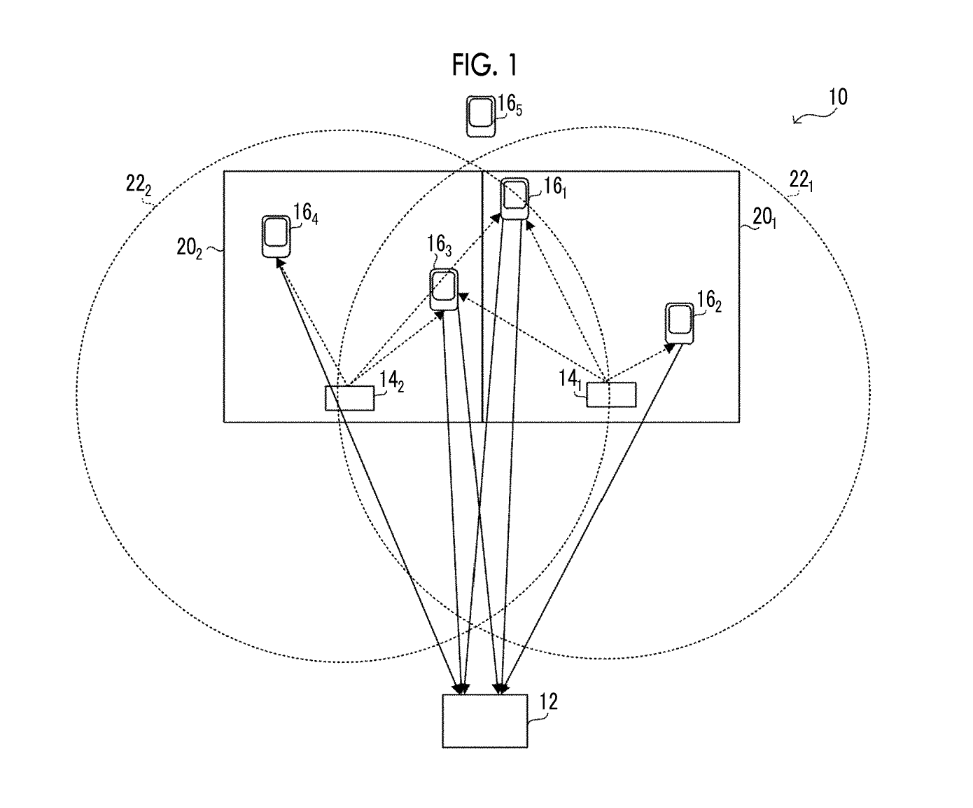

FIG. 1 is a configuration diagram showing an example of an overall configuration of an attendance status management system 10 according to the present exemplary embodiment. As shown in FIG. 1, the attendance status management system 10 of the present exemplary embodiment includes a server 12, plural teacher terminals 14 (two teacher terminals 14₁, 14₂ in FIG. 1) and plural student terminals 16 (five student terminals 16₁ to 16₅ in FIG. 1). In the following, the teacher terminals 14₁, 14₂ are collectively referred to as “teacher terminal 14” in a case where they are not distinguished from each other. In a case where they are distinguished from each other, signs (1, 2) are added for distinguishing individuals. Similarly, student terminal 16₁ to 16₅ are collectively referred to as “student terminal 16” in a case where they are not distinguished from each other. In a case where they are distinguished from each other, signs (1 to 5) are added for distinguishing individuals.

The teacher terminal 14 is a terminal device possessed by each teacher, and in a case where a teacher gives a class, the teacher terminal 14 is brought into a classroom where the teacher gives the class. The teacher terminal 14 of the present exemplary embodiment is an example of a main terminal device of the present disclosure, and the classroom of the present exemplary embodiment is an example of an area which is an attendance target in the present disclosure. In FIG. 1, a teacher terminal 14₁ is brought into the classroom 20₁ by a teacher who performs a class in the classroom 20₁, and a teacher terminal 14₂ is brought into the classroom 20₂ by a teacher who performs a class in the classroom 20₂.

The teacher terminal 14 has a function of Beacon. The teacher terminal 14 repeatedly transmits a beacon signal to which teacher terminal position information indicating the position of the teacher terminal 14 and a beacon identification (ID) (both of which will be described in detail later) are attached, in a time period in which a teacher as an owner is performing a class.

In a case where the student terminal 16 is a terminal device owned by a student and the student attends a class to be taken, the student terminal 16 is brought into a classroom where the student takes the class. Specific examples of the student terminal 16 include a portable information terminal device such as a smartphone. The student of the present exemplary embodiment is an example of the owner in the present disclosure, and the student terminal 16 of the present exemplary embodiment is an example of a sub terminal device in the present disclosure.

The “owner” refers to a person who actually uses each device as the user of the teacher terminal 14 or the student terminal 16. For example, it does not matter whether or not the owner is the holder of the teacher terminal 14 or the student terminal 16.

FIG. 1 shows the state where a student terminal 16₁ and a student terminal 16₂ are brought into the classroom 20₁ by two students, and a student terminal 16₃ and a student terminal 16₄ are brought into the classroom 20₂ by the other two students.

In a case of receiving the beacon signal from the teacher terminal 14, the student terminal 16 transmits the beacon ID and the teacher terminal position information which are included in the received beacon signal, student terminal position information indicating the position of the student terminal 16, user identification information, and distance information indicating a distance to the teacher terminal 14 (all of which will be described later in detail) to the server 12.

The server 12 manages the attendance status of students to the class, based on the received beacon ID, teacher terminal position information, student terminal position information, user identification information, and distance information. The server 12 of the present exemplary embodiment is an example of the attendance status management apparatus of the present disclosure.

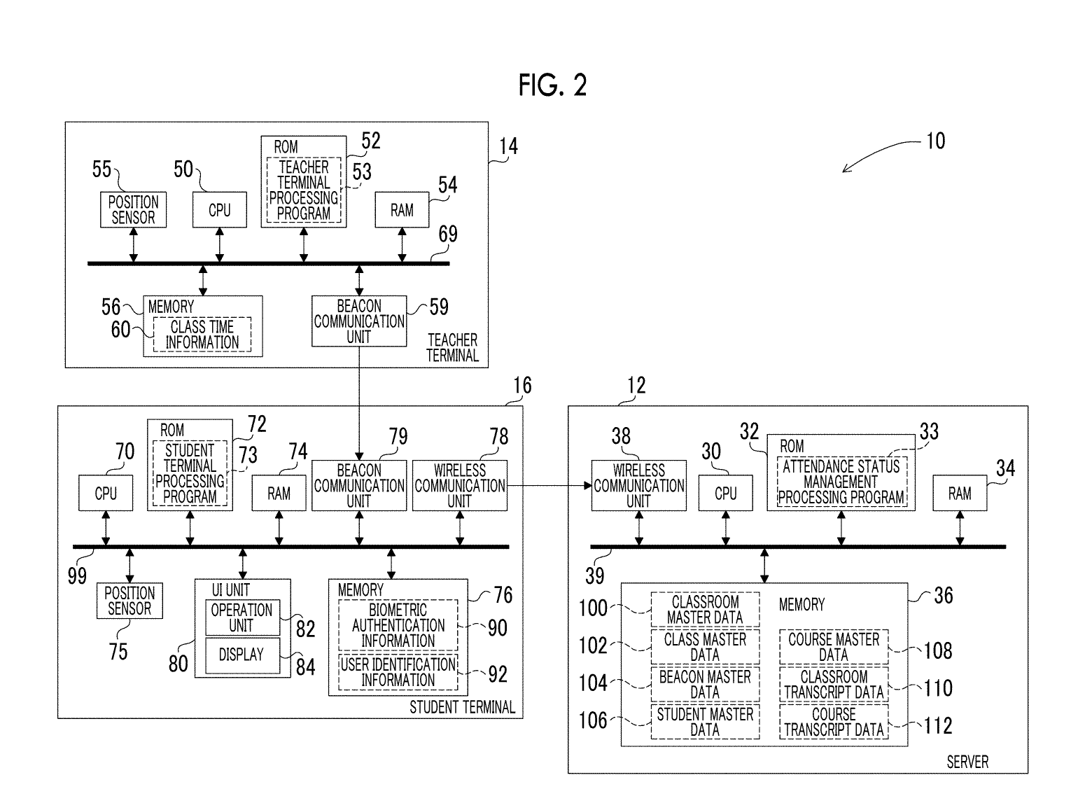

FIG. 2 shows a block diagram showing an example of the configurations of the server 12, the teacher terminal 14, and the student terminal 16 of the present exemplary embodiment.

As shown in FIG. 2, the teacher terminal 14 of the present exemplary embodiment includes a central processing unit (CPU) 50, a read only memory (ROM) 52, a random access memory (RAM) 54, a position sensor 55, a memory 56, and a beacon communication unit 59. The CPU 50, the ROM 52, the RAM 54, the position sensor 55, the memory 56, and the beacon communication unit 59 are connected through a bus 69 such as a system bus or a control bus.

The CPU 50 controls the operation of the teacher terminal 14 by executing various programs such as a teacher terminal processing program 53. In the ROM 52, various programs such as the teacher terminal processing program 53 executed by the CPU 50, various parameters, and the like are stored in advance. The RAM 54 is used as a work area or the like when the CPU 50 executes various programs.

The position sensor 55 is a sensor for detecting the position of the teacher terminal 14, and in this exemplary embodiment, a global positioning system (GPS) sensor is used as an example.

The memory 56 is a hard disk drive (HDD), a solid state drive (SSD), or the like, and stores class time information 60 representing the time period of a class conducted by a teacher who is the owner of the teacher terminal 14. A method of storing the class time information 60 in the memory 56 is not particularly limited, and may be stored by a teacher, an administrator of the server 12, or the like through the server 12, for example.

The beacon communication unit 59 has a function of transmitting a beacon signal to which the teacher terminal position information and the beacon ID are attached as described above. In this exemplary embodiment, a beacon signal is transmitted by Bluetooth (registered trademark) Low Energy (BLE) as an example. The teacher terminal position information attached to the beacon signal is GPS information indicating the position of the teacher terminal 14 detected by the position sensor 55. The teacher terminal position information of the present exemplary embodiment is an example of main terminal position information in the present disclosure. In addition, the beacon ID is identification information for identifying the beacon signal that the teacher terminal 14 outputs, and is stored in, for example, the ROM 52 or the like.

Meanwhile, as shown in FIG. 2, the student terminal 16 of this exemplary embodiment includes a CPU 70, a ROM 72, a RAM 74, a position sensor 75, a memory 76, a wireless communication unit 78, a beacon communication unit 79, and a user interface (UI) unit 80. The CPU 70, the ROM 72, the RAM 74, the position sensor 75, the memory 76, the wireless communication unit 78, the beacon communication unit 79, and the UI unit 80 are connected through a bus 99 such as a system bus and a control bus.

The CPU 70 controls the operation of the student terminal 16 by executing various programs such as a student terminal processing program 73. In the ROM 72, various programs such as the student terminal processing program 73 executed by the CPU 70, various parameters, and the like are stored in advance. The RAM 74 is used as a work area or the like when the CPU 70 executes various programs.

The position sensor 75 is a sensor that detects the position of the student terminal 16, and in this exemplary embodiment, a GPS sensor is used as an example.

The memory 76 is an HDD, an SSD or the like, and stores biometric authentication information 90 which is ecological information used for biometric authentication of the owner of the student terminal 16, and user identification information 92 for the server 12 to identify the owner (user) of the student terminal 16. In the present exemplary embodiment, a student ID is employed as an example of the user identification information 92.

The UI unit 80 includes an operation unit 82 and a display 84. The operation unit 82 is used for the owner to input various instructions, various types of information, and the like. The display 84 visually displays various types of information. In addition, the UI unit 80 may be configured using a touch panel display in which the operation unit 82 and the display 84 are integrated. The UI unit 80 detects the operation state of the operation unit 82 and controls display of various types of information on the display 84.

The beacon communication unit 79 has a function of receiving the beacon signal to which the teacher terminal position information and the beacon ID are attached, transmitted by the teacher terminal 14.

The wireless communication unit 78 has a function of communicating with external devices such as the server 12 by a wireless communication system such as WiFi (registered trademark) or Bluetooth (registered trademark). The wireless communication unit 78 according to the present exemplary embodiment transmits a beacon ID, teacher terminal position information, student terminal position information, user identification information, and distance information to the server 12 by wireless communication. The transmitted beacon ID and teacher terminal position information are attached to the beacon signal received from the teacher terminal 14. Meanwhile, the student terminal position information is GPS information indicating the position of the student terminal 16 detected by the position sensor 75. The student terminal position information of the present exemplary embodiment is an example of sub terminal position information in the present disclosure. Further, the user identification information is the user identification information 92 stored in the memory 76. The distance information is information indicating whether the distance to the teacher terminal 14 determined by the intensity of the received beacon signal is a short distance, a medium distance, or a long distance.

Meanwhile, as shown in FIG. 2, the server 12 of this exemplary embodiment includes a CPU 30, a ROM 32, a RAM 34, a memory 36, and a wireless communication unit 38. The CPU 30, the ROM 32, the RAM 34, the memory 36, and the wireless communication unit 38 are connected through a bus 39 such as a system bus or a control bus.

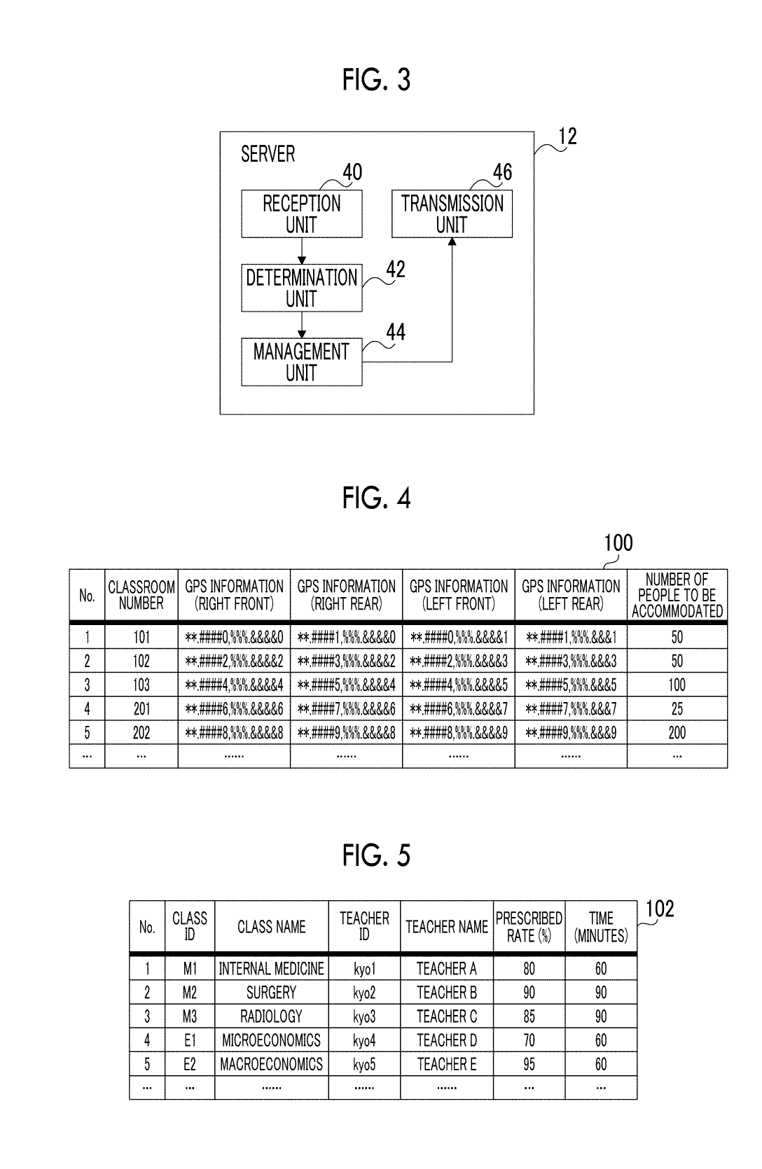

The CPU 30 controls the operation of the server 12 by executing various programs such as the attendance status management processing program 33. By executing the attendance status management processing program 33, the CPU 30 according to the present exemplary embodiment functions as the determination unit 42 and the management unit 44 (both of which will be described in detail later) shown in FIG. 3. In the ROM 32, various programs such as an attendance status management processing program 33 executed by the CPU 30, various parameters, and the like are stored in advance. The RAM 34 is used as a work area or the like when the CPU 30 executes various programs.

The wireless communication unit 38 has a function of communicating with external devices such as the student terminal 16 by a wireless communication system such as WiFi (registered trademark) or Bluetooth (registered trademark). The wireless communication unit 38 of the present exemplary embodiment receives the beacon ID, the teacher terminal position information, the student terminal position information, the user identification information, and the distance information from the student terminal 16 by wireless communication.

The memory 36 is an HDD, an SSD, or the like, and stores the biometric authentication information 90, the classroom master data 100, the class master data 102, the beacon master data 104, the student master data 106, the course master data 108, the classroom transcript data 110, and the course transcript data 112, which are used for biometric authentication of the owner of the server 12.

The classroom master data 100 is a database that defines the position of each classroom where a class is performed. In the classroom master data 100 of this exemplary embodiment, as shown in FIG. 4, as an example, a classroom number which is information for identifying a classroom, information defining the position of the classroom, and the number of people to be accommodated are associated with each other. In the present exemplary embodiment, as an example, the position of the classroom is defined by GPS information of four corners (right front, right rear, left front, and left rear in a case of viewing from a predetermined direction) of a classroom having a rectangular shape in plan view. In FIG. 4, the value of GPS as GPS information is expressed using Degree Minute Second (DMS) notation but it may be Degree (DEG) notation, and for example, it is preferable that teacher terminal position information and student terminal position information are expressed using the same notation. In addition, the method of defining the position of the classroom is not limited to the present exemplary embodiment. For example, the center position and radius of the classroom may be defined and the inside of a circle defined by the center position and the radius may be regarded as the position of the classroom. However, by adopting a definition method according to the shape of the classroom, the position of the classroom can be defined more accurately. In addition, in FIG. 4, the number of people to be accommodated in each classroom is also associated, but it is not indispensable.

The class master data 102 is a database that defines a teacher who conducts a class for each class. As shown in FIG. 5 as an example, in the class master data 102 of this exemplary embodiment, a class ID which is information for identifying a class, a class name, a teacher ID which is information for identifying a teacher, a teacher name, a prescribed rate, and the class time are associated with each other.

The prescribed rate is a threshold used for determining whether or not a student has attended the associated class. For example, there are cases where students do not participate in classes from the start to the end of the class (not in classrooms), such as in a case where students taking corresponding classes are late or a case where students leave classrooms during the classes. Therefore, the server 12 manages that the student attends a class, in a case where the rate of the time during which the student is staying in the classroom with respect to one class time (hereinafter referred to as “stay rate”) is equal to or more than the prescribed rate. The prescribed rate may be set by teachers or the like.

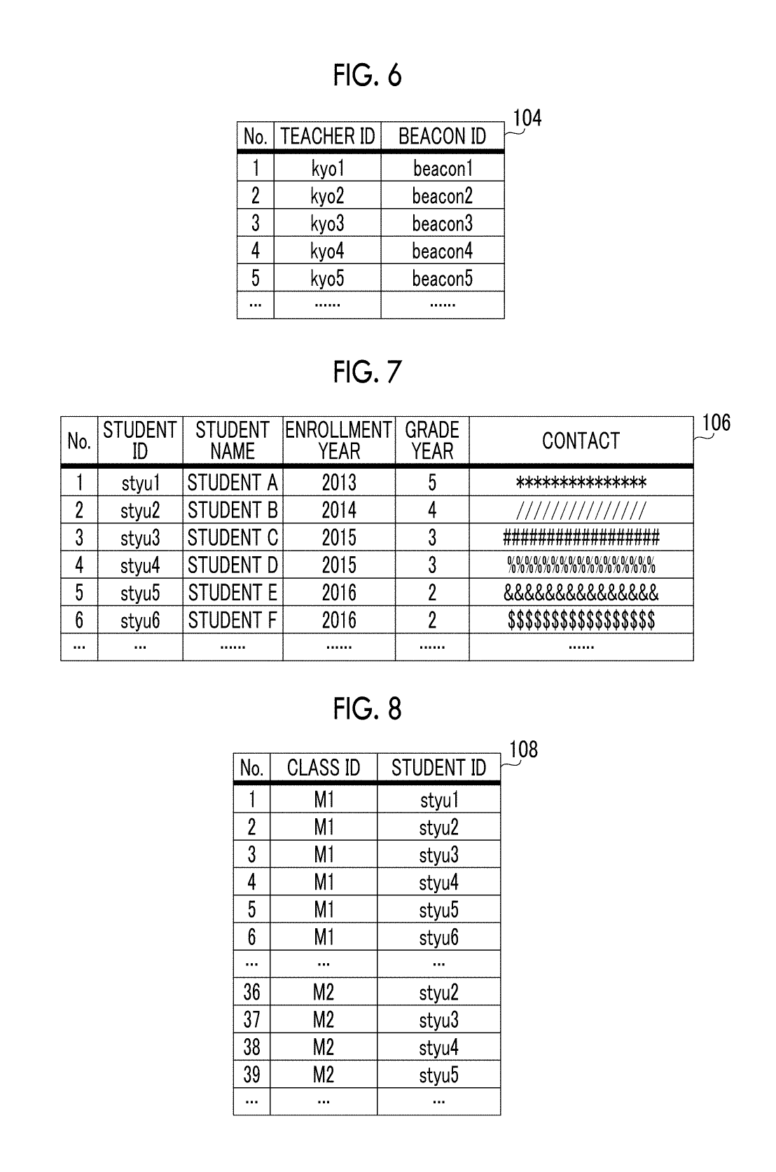

The beacon master data 104 is a database that defines a teacher who owns the teacher terminal 14. In the beacon master data 104 of this exemplary embodiment, as shown in FIG. 6 as an example, the teacher ID of the teacher and the beacon ID of the teacher terminal 14 owned by the teacher are associated with each other.

The student master data 106 is a database that defines the students going to the school, who are managed by the attendance status management system 10. As shown in FIG. 7 as an example, in the student master data 106 of the present exemplary embodiment, a student ID (corresponding to the user identification information 92), a student name, an enrollment year, a grade year, and a contact are associated with each other.

The course master data 108 is a database that defines which students to take which class. As shown in FIG. 8, as an example, in the course master data 108 of the present exemplary embodiment, a class ID and a student ID of a student who is taking the class are associated with each other for each class ID of each class.

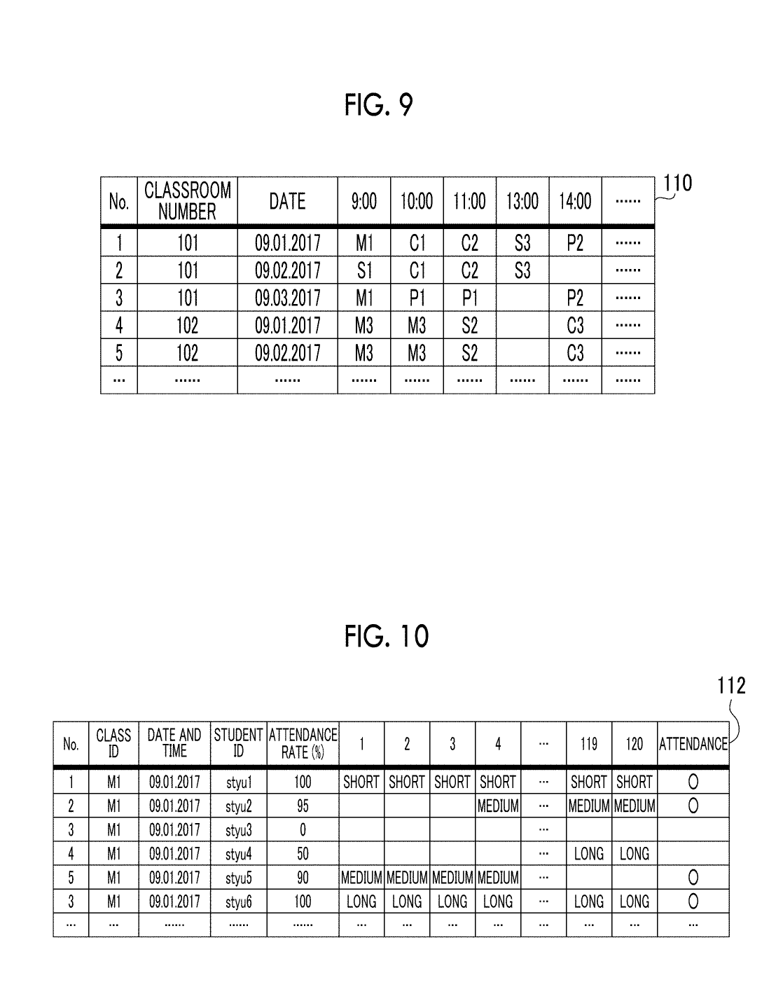

The classroom transcript data 110 is a database that defines for each classroom, classes using the classroom. As shown in FIG. 9 as an example, in the classroom transcript data 110 of the present exemplary embodiment, a classroom number, a date to use a classroom (year, month, day), and a class ID representing a class used every hour are associated with each other.

The course transcript data 112 is a database for managing the attendance status of a student for each class. As shown in FIG. 10 as an example, in the course transcript data 112 of this exemplary embodiment, a class ID, a date and time at which the class is performed, a student ID of a student who is required to take a class, an attendance rate, a distance between the teacher terminal 14 and the student terminal 16 (see “1” to “120” in FIG. 10, to be described below in detail), and information indicating whether or not a student has attended (see the “attendance” item in FIG. 10) are associated with each other.

Meanwhile, FIG. 3 shows a block diagram showing functions of the server 12 according to the present exemplary embodiment. As shown in FIG. 3, the server 12 of the present exemplary embodiment includes a reception unit 40, a determination unit 42, a management unit 44, and a transmission unit 46.

The reception unit 40 has a function of receiving various types of information from an external device by the above-described wireless communication unit 38.

The determination unit 42 has a function of determining whether or not the position of the student terminal 16 is a position within a predetermined distance from the teacher terminal 14, and determining whether or not the position of the student terminal 16 is a position within the classroom where the class to be attended is performed.

The management unit 44 has a function of managing the attendance status of the student who is the owner of the student terminal 16, based on the determination result of the determination unit 42.

The transmission unit 46 has a function of transmitting various types of information to the external device by the above-described wireless communication unit 38.

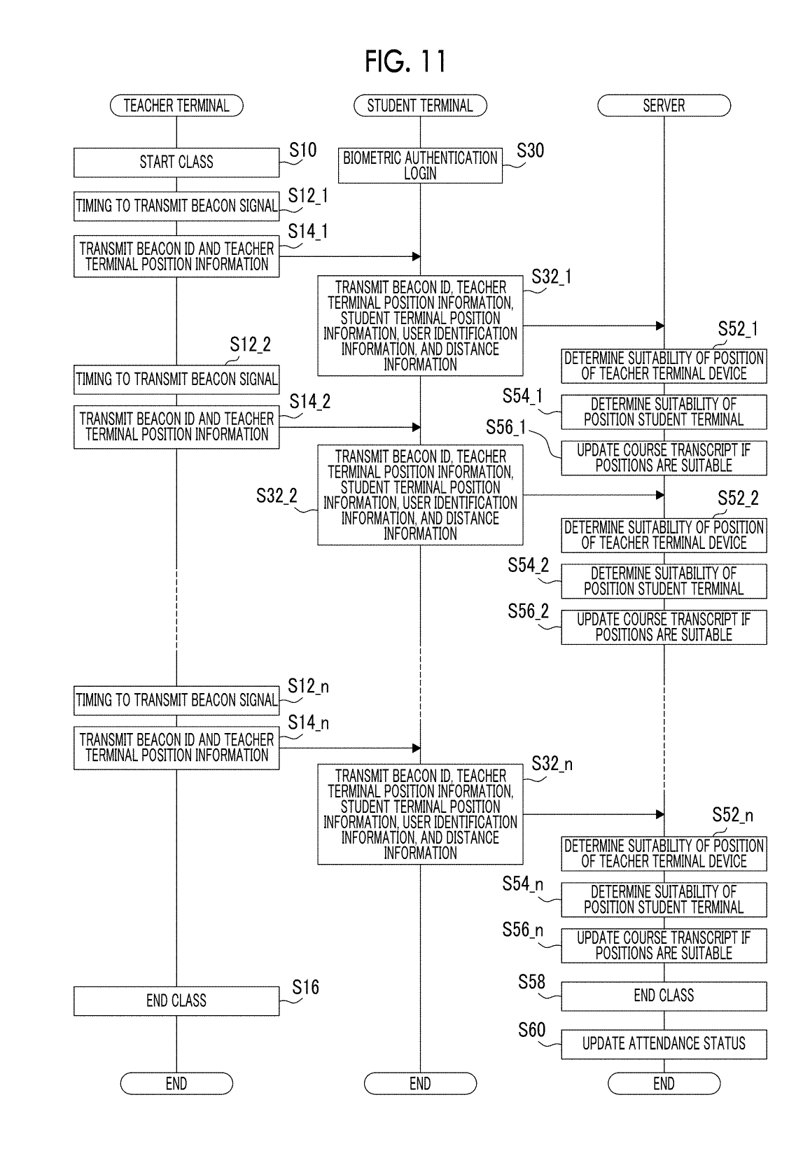

Next, the operation of the attendance status management system 10 of this exemplary embodiment will be described. FIG. 11 is a time chart showing an example of operations of the server 12, the teacher terminal 14, and the student terminal 16 from the start to the end of a class. In the following, individual operations of the server 12, the teacher terminal 14, and the student terminal 16 will be described using corresponding flowcharts, with reference to FIG. 11.

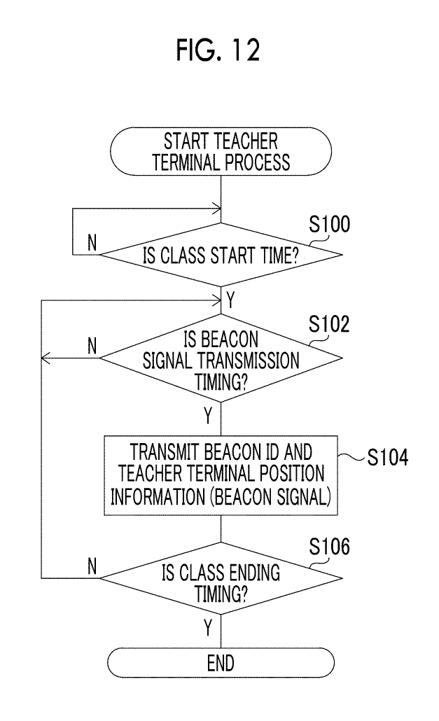

First, the operation of the teacher terminal 14 will be described. FIG. 12 is a flowchart showing an example of a flow of a teacher terminal process executed by the teacher terminal of the present exemplary embodiment. In the present exemplary embodiment, in a case where the teacher terminal 14 is turned on by the teacher before the start of the class, the teacher terminal process shown in FIG. 12 is executed by the CPU 50 executing the teacher terminal processing program 53 stored in the ROM 52.

In step S100, the CPU 50 refers to the class time information 60 stored in the memory 56 and determines whether or not it is time to start the corresponding class. In a case where it is not yet time to start the class, a negative determination is made at step S100. On the other hand, in a case where it is time to start the class, an affirmative determination is made in step S100 (see S10 in FIG. 11), and the process goes to step S102.

In step S102, the CPU 50 determines whether or not it is a timing to transmit a beacon signal. The teacher terminal 14 of the present exemplary embodiment repeatedly transmits the beacon signal during a class, for example, regularly at a predetermined timing such as every few minutes, every tens of seconds, or the like. It should be noted that the predetermined timing for transmitting the beacon signal is any timing and can be set by a teacher, an administrator or the like.

In a case where the timing to transmit the beacon signal is not reached, a negative determination is made in step S102. On the other hand, in a case where the timing to transmit the beacon signal is reached (see S12_1, S12_2, . . . , S12_n in FIG. 11), an affirmative determination is made in step S102 and the process goes to step S104.

In step S104, the CPU 50 transmits a beacon signal to which the beacon ID and the teacher terminal position information acquired from the position sensor 55 are attached (see S14_1, S14_2, . . . , S14_n in FIG. 11).

In the next step S106, the CPU 50 refers to the class time information 60 stored in the memory 56 and determines whether or not the ending time of the corresponding class is reached. In a case where the class is still in progress, the determination in step S106 is negative, the process returns to step S102, and the process in step S104 is repeated.

On the other hand, in a case where the ending time of the corresponding class is reached, an affirmative determination is made in step S106 (see S16 of FIG. 11), and the teacher terminal process is ended. In the present exemplary embodiment, in a case where the teacher terminal process is ended, the CPU 50 turns off the power of the teacher terminal 14.

As described above, the teacher terminal 14 of the present exemplary embodiment repeatedly transmits the beacon signal to which the beacon ID and teacher terminal position information are attached, at a predetermined timing, while the class is being performed.

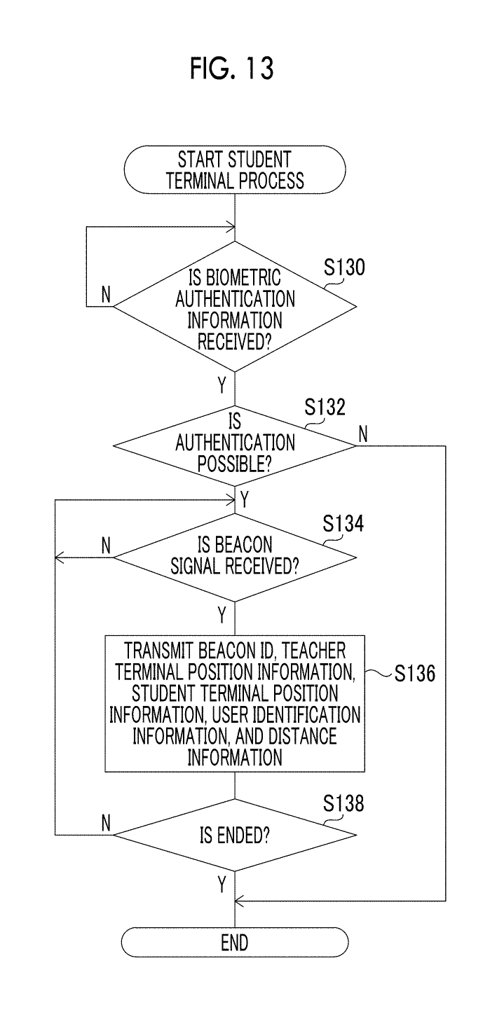

Next, the operation of the student terminal 16 will be described. FIG. 13 is a flowchart showing an example of a flow of a student terminal process executed by the student terminal 16 of the present exemplary embodiment. In the present exemplary embodiment, in a case where the student instructs to execute the student terminal process before start of the class, the student terminal process shown in FIG. 13 is executed by the CPU 70 executing the student terminal processing program 73 stored in the ROM 72.

In step S130, the CPU 70 determines whether or not biometric authentication information for biometric authentication is received from the student who is the owner, by the operation unit 82. The method of performing biometric authentication by the student terminal 16 of the present exemplary embodiment is not particularly limited, and techniques such as fingerprint authentication, voiceprint authentication, and iris authentication can be applied. In a case where biometric authentication information is not received, a negative determination is made in step S130 is negative. On the other hand, in a case where the biometric authentication information is received, an affirmative determination is made in step S130, and the process proceeds to step S132.

In step S132, the CPU 70 compares the biometric authentication information received in step S130 with the biometric authentication information 90 stored in the memory 76, and determines whether to perform authentication. In a case where it is regarded that the received biometric authentication information and the biometric authentication information 90 do not match, authentication is not made, so a negative determination is made in step S132 and the student terminal process is ended. On the other hand, in a case where it is regarded that the received biometric authentication information and the biometric authentication information 90 match each other, authentication is made, so an affirmative determination is made in step S132, the login state is set (see S30 in FIG. 11), and the process proceeds to step S134.

In step S134, the CPU 70 determines whether or not a beacon signal is received from the teacher terminal 14. In a case where the beacon signal is not received, a negative determination is made in step S134. On the other hand, in a case where a beacon signal is received, an affirmative determination is made in step S134, and the process proceeds to step S136. In the attendance status management system 10 of the present exemplary embodiment, in a case where the student terminal 16 is within a range that the beacon signal of the teacher terminal 14 reaches, the student terminal 16 receives the beacon signal of the teacher terminal 14 used for another class which is performed at the same time period. For example, the student terminal 16₁ shown in FIG. 1 takes the class by the teacher who owns the teacher terminal 14₁ in the classroom 20₁, and is in the beacon area 22₁ that the beacon signal of the teacher terminal 14₁ arrives. Further, since the student terminal 16₁ is also in the beacon area 22₂ of the teacher terminal 14₂ owned by the teacher who conducts the class in the next classroom 20₂, the student terminal 16₁ also receives the beacon signal transmitted by the teacher terminal 14₂.

In step S136, the CPU 70 transmits the beacon ID, the teacher terminal position information, and the distance information, which are acquired from the received beacon signal, the student terminal position information acquired from the position sensor 75, and the user identification information (student ID) acquired from the user identification information 92 of the memory 76 to the server 12 (see S32_1, S32_2, . . . , S32_n in FIG. 11).

In the next step S138, the CPU 70 determines whether or not to end the student terminal process. As an example, in the student terminal 16 of the present exemplary embodiment, a negative determination is made in step S138 until the student instructs the end of the execution of the student terminal process, the process returns to step S134, and the determination in step S136 is repeated. On the other hand, in a case where the student instructs the end of the execution of the student terminal process, an affirmative determination is made in step S138, and the student terminal process is ended.

As described above, in a case where the student terminal 16 of the present exemplary embodiment is authenticated as an authorized owner by biometric authentication, each time the student terminal 16 receives a beacon signal, until the end of the student terminal process is instructed, the student terminal 16 transmits the beacon ID, the teacher terminal position information, the student terminal position information, the user identification information (student ID), and the distance information to the server 12.

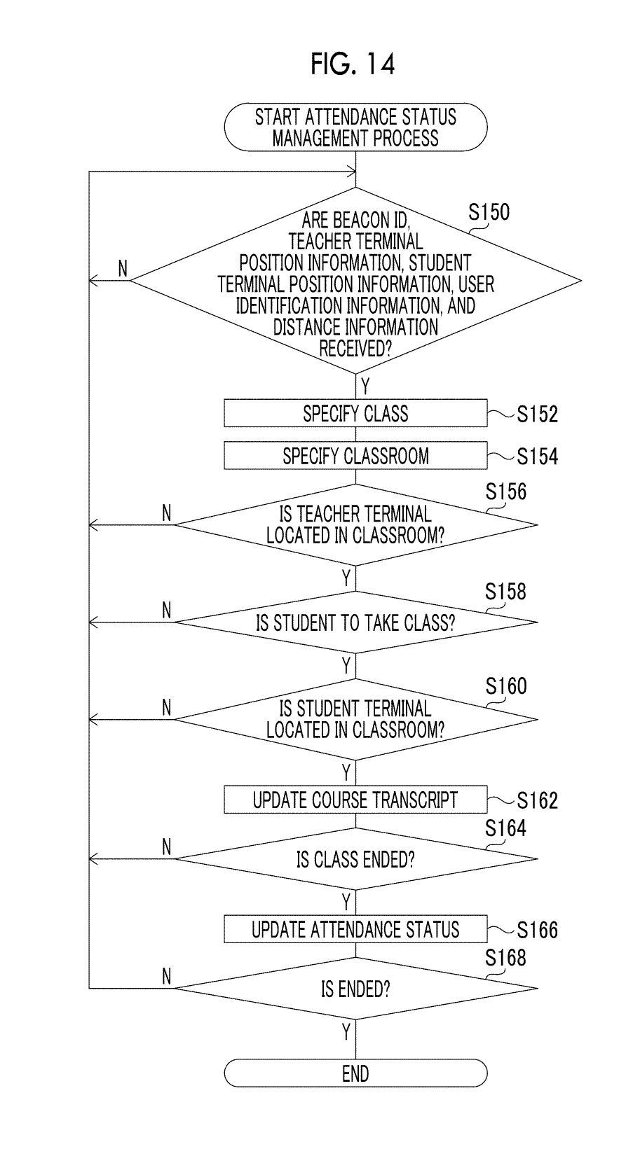

Next, the operation of the server 12 will be described. FIG. 14 is a flowchart showing an example of a flow of an attendance status management process executed by the server of the present exemplary embodiment. In the present exemplary embodiment, in a case where the server 12 is turned on, the CPU 30 executes the attendance status management processing program 33 stored in the ROM 32, thereby the server 12 functions as the determination unit 42 and the management unit 44 as described above and the attendance status management process shown in FIG. 14 is executed. The attendance status management processing program 33 of the present exemplary embodiment is an example of the attendance status management program in the present disclosure.

In step S150, the determination unit 42 determines whether or not the beacon ID, the teacher terminal position information, the student terminal position information, the user identification information (student ID), and the distance information are received from the student terminal 16. In a case where the beacon ID, the teacher terminal position information, the student terminal position information, the user identification information (student ID), and the distance information are not received, a negative determination is made in step S150. On the other hand, in a case where the beacon ID, the teacher terminal position information, the student terminal position information, the user identification information (student ID), and the distance information are received, an affirmative determination is made in step S150 and the process proceeds to step S152.

In step S152, the determination unit 42 specifies the class that the student who is the owner of the student terminal 16 which is the transmission source of the information received in step S150 is attending. Specifically, the determination unit 42 refers to the beacon master data 104 and specifies the teacher ID corresponding to the received beacon ID. Furthermore, the determination unit 42 refers to the class master data 102 and specifies the class ID corresponding to the specified teacher ID.

In the next step S154, the determination unit 42 specifies the classroom where the class specified in the above step S152 is being performed. Specifically, the determination unit 42 refers to classroom transcript data 110 and the clock (not shown) and specifies the classroom number corresponding to the specified class ID and the current year, month, day and time.

In the next step S156, the determination unit 42 determines whether or not the teacher terminal 14 is located in the classroom specified in the above step S154, that is, determines the suitability of the position of the teacher terminal 14 (steps S52_1, S52_2, . . . , S52_n in FIG. 11). Specifically, the determination unit 42 refers to the classroom master data 100 and specifies the GPS information corresponding to the classroom number specified in the above step S154. Then, the determination unit 42 determines whether or not the position of the teacher terminal 14 represented by the received teacher terminal position information is included in the area represented by the specified GPS information. In a case where the teacher terminal 14 is not located in the classroom, a negative determination is made in step S156, and the process returns to step S150. On the other hand, in a case where the teacher terminal 14 is located in the classroom, an affirmative determination is made in step S156, and the process proceeds to step S158.

In step S158, the determination unit 42 determines whether or not the student who is the owner of the student terminal 16 which is the transmission source of the information received in step S150 is a student taking the class specified in the above step S152. Specifically, the determination unit 42 refers to the course master data 108 and determines whether or not the received student ID is associated with the class ID of the specified class. In a case where the received student ID is not associated with the class ID of the specified class, a negative determination is made in step S158, and the process returns to step S150. For example, as described above, the student terminal 16₁ shown in FIG. 1 transmits a beacon ID, teacher terminal position information, student terminal position information, user identification information (student ID), and distance information to the server 12, in response to the beacon signal transmitted from the teacher terminal 14₂ of the next classroom 20₂. In this case, the determination unit 42 specifies the classroom 20₂, but since the student who is the owner of the student terminal 16₁ is not supposed to take the class performed in the classroom 20₂, a negative determination is made in step S158. On the other hand, in a case where the received student ID is associated with the class ID of the specified class, an affirmative determination is made in step S158 and the process proceeds to step S160.

In step S160, the determination unit 42 determines whether the student terminal 16 is located in the classroom specified in the above step S154, that is, determines the suitability of the position of the student terminal 16 (see steps S54_1, S54_2, S54_n in FIG. 11). Specifically, the determination unit 42 determines whether or not the position of the student terminal 16 represented by the received student terminal position information is included in the area represented by the GPS information specified in the above step S156. In a case where the student terminal 16 is not located in the specified classroom, a negative determination is made in step S158, and the process returns to step S150.

For example, a student who is the owner of the student terminal 16₃ shown in FIG. 1 is supposed to attend the class performed in the classroom 20₁, but the student is attending the class performed in the classroom 20₂. In this case, since the student terminal 16₃ is located within the beacon area 22 of the teacher terminal 14₁, it transmits a beacon ID, teacher terminal position information, student terminal position information, user identification information, and distance information to the server 12, in response to the beacon signal of the teacher terminal 14₁. The determination unit 42 specifies the classroom 20₁ from the received information, but since the position of the student terminal 16₃ is specified as being outside the classroom 20₁, a negative determination is made in step S158. On the other hand, in a case where the student terminal 16 is located in the specified classroom, an affirmative determination is made in step S158, and the process proceeds to step S162.

In step S162, based on the determination result of the determination unit 42 described above, the management unit 44 updates the attendance status of the student who is the owner of the student terminal 16 which is the transmission source of the information received in the above step S150, in the course transcript data 112 (see steps S56_1, S56_2, S56_n in FIG. 11). Specifically, the management unit 44 updates the distance (one of a short distance, a medium distance, and a long distance) between the teacher terminal 14 and the student terminal 16, in the course transcript data 112, plural times (120 times in FIG. 10) at every predetermined time according to the timing at which the teacher terminal 14 transmits the beacon signal, for each student to be managed.

In the next step S164, the management unit 44 determines whether or not the class specified in the above step S154 has ended. In the present exemplary embodiment, the management unit 44 acquires the class time of the specified class from the class master data 102, and determines that the specified class has ended in a case where the class time has elapsed from the class start time.

In a case where the specified class has not ended, a negative determination is made in step S164, the process returns to step S150, and each of the processes in steps S152 to S162 is repeated. On the other hand, in a case where the specified class ends, an affirmative determination is made in step S164, and the process proceeds to step S166.

In step S166, the management unit 44 updates the attendance status of the student who is the owner of the student terminal 16 which is the transmission source of the information received in step S150. Specifically, the management unit 44 derives the current stay rate of the student to be updated, in the class that is determined to have ended. There is no particular limitation on the method by which the management unit 44 derives the stay rate. For example, for the student to be updated, the ratio of the number of times the course transcript data 112 is updated in the above step S162 or the number of times the distance information is written in the course transcript data 112 with respect to the number of times the teacher terminal 14 transmits the beacon signal (120 times in FIG. 10) during one class may be derived.

The management unit 44 of the present exemplary embodiment acquires the prescribed rate of the class determined to have ended from the class master data 102 and determines whether or not the derived stay rate is equal to or higher than the prescribed rate. In a case where the derived stay rate is equal to or higher than the prescribed rate, it is managed that the student to be updated attends the class to be attended, and the attendance status is updated by adding information (“∘” mark in FIG. 10) indicating that attendance to the “attendance” item of the course transcript data 112. On the other hand, in a case where the derived stay rate is less than the prescribed rate, it is managed that the student to be updated is absent from the class to be attended, and the attendance status is updated by not adding any information to the “attendance” item of the course transcript data 112.

Further, the management unit 44 of the present exemplary embodiment derives the attendance rate of the student to be updated to the class to be attended, and adds the derived attendance rate to the item of “attendance rate” of the course transcript data 112. In the present exemplary embodiment, “attendance rate” refers to the rate at which a student attends a class to take, specifically, a ratio of the number of times a student, who is required to take the class, attends the class with respect to the number of times the class has already been performed.

In the next step S168, the determination unit 42 determines whether to end the attendance status management process. As an example, in the server 12 of the present exemplary embodiment, a negative determination is made in step S168 until the administrator or the like managing the attendance status instructs the end of the execution of the attendance status management process, the process returns to step S150, and each process of step S152 to S166 is repeated. On the other hand, in a case where the administrator or the like managing the attendance status instructs the end of the execution of the attendance status management process, an affirmative determination is made in step S168, and the attendance status management process is ended.

In the present exemplary embodiment, the course transcript data 112 updated by the attendance status management process is accumulated in the memory 36 of the server 12 as information indicating the attendance status of the student.

As described above, in the attendance status management system 10 according to the present exemplary embodiment, when a class to be attended is conducted, the teacher terminal 14 is brought by the teacher who owns the teacher terminal 14 into the classroom where the class is conducted. The teacher terminal 14 repeatedly transmits at a predetermined timing during the class to be attended, a beacon signal to which the beacon ID and the teacher terminal position information are attached. In a case where the student terminal 16 owned by the student receives the beacon signal from teacher terminal 14, it transmits a beacon ID, teacher terminal position information, student terminal position information, user identification information, and distance information to server 12.

In a case where it is determined that the student terminal 16 is located within a predetermined distance from the teacher terminal 14 corresponding to the beacon signal and the student terminal 16 is located in a classroom where the class to be taken is performed, the server 12 determines that the student who is the owner of student terminal 16 stays in the classroom and updates the course transcript data 112. Then, the server 12 manages the attendance status of the student having a stay rate equal to or higher than the prescribed rate defined for each class as attendance. On the other hand, the server 12 manages the attendance status of the student having a stay rate less than the prescribed rate as absence. That is, in a case where the position of the student terminal 16 is at least one of the position outside a predetermined distance from the teacher terminal 14 or the position of the student terminal 16 is position outside a classroom where the class to be taken is performed, the server 12 manages the attendance status of the student who is the owner of student terminal 16 as absence.

In this way, the server 12 manages the attendance status of the student, which makes it possible to correctly manage the attendance status. For example, in the example shown in FIG. 1, since the student who owns the student terminal 16₁ and the student who owns the student terminal 16₂ are within the beacon area 22₁ of teacher terminal 14₁ and the classroom 20₁, in a case where the stay rate is equal to or greater than the prescribed rate, the server 12 determines that the students attend the class performed in the classroom 20₁, with respect to the attendance status of the students. Since the student who owns the student terminal 16₃ and the student who owns the student terminal 16₄ are within the beacon area 22₂ of teacher terminal 14₂ and the classroom 20₂, in a case where the stay rate is equal to or greater than the prescribed rate, the server 12 determines that the students attend the class performed in the classroom 20₂, with respect to the attendance status of the students. On the other hand, in a case where the student who owns the student terminal 16₅ is a student who is required to take a class performed in the classroom 20₁, the position of the student terminal 16₅ is not within the beacon area 22₁, so the server 12 manages the attendance status of the student as absence.

### Second Exemplary Embodiment

In the present exemplary embodiment, a form to display the attendance status based on the information indicating the student's attendance status such as the course transcript data 112 accumulated in the server 12 in the attendance status management system 10 of the first exemplary embodiment will be described.

In the attendance status management system 10, detailed description of the same configuration and operation as in the first exemplary embodiment will be omitted.

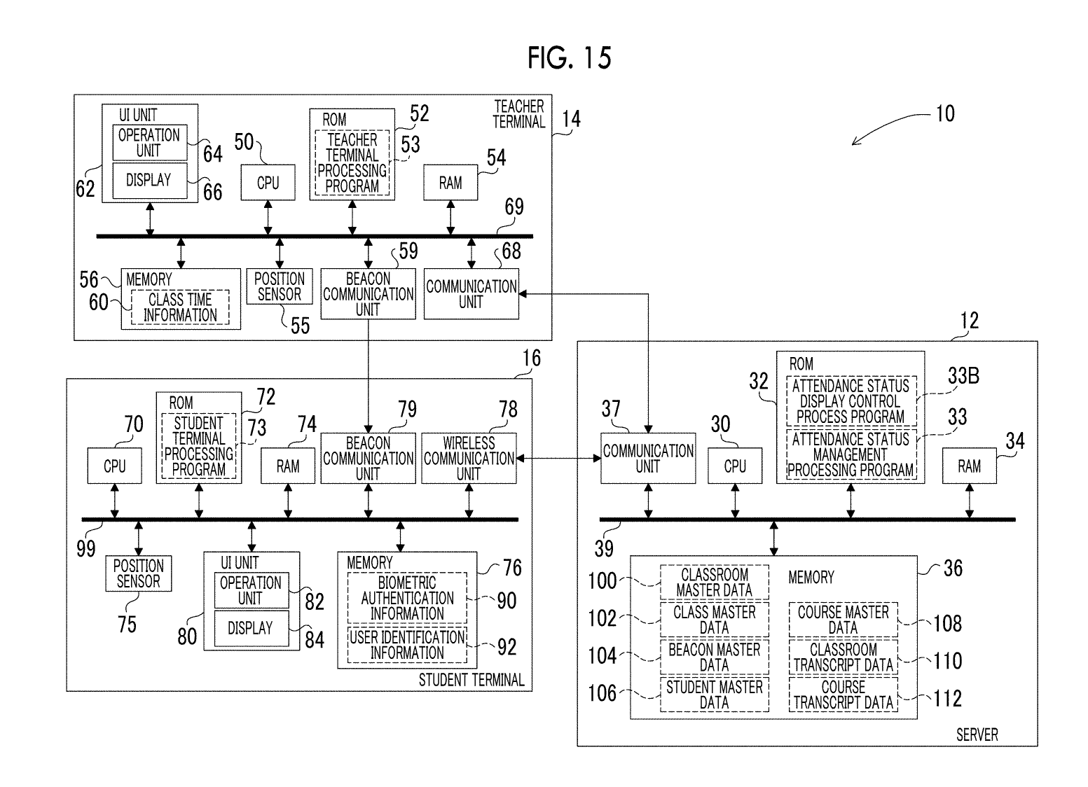

First, the configuration of the attendance status management system 10 of the present exemplary embodiment will be described. FIG. 15 shows a block diagram showing an example of the configurations of the server 12, the teacher terminal 14, and the student terminal 16 of the present exemplary embodiment. As shown in FIG. 15, the teacher terminal 14 of the present exemplary embodiment is different from the teacher terminal 14 (see FIG. 2) of the first exemplary embodiment in that it has a UI unit 62 and a communication unit 68.

The UI unit 62 includes an operation unit 64 and a display 66. The operation unit 64 is used for a teacher who is the owner to input an instruction or the like to display information on the attendance status. The display 66 visually displays information on the attendance status and the like. In addition, the UI unit 62 may be configured using a touch panel display in which the operation unit 64 and the display 66 are integrated. The UI unit 62 detects the operation state of the operation unit 64 and controls display of various types of information on the display 66. Further, the communication unit 68 has a function of communicating with the server 12 by wired communication or wireless communication. The UI unit 62 and the communication unit 68 are connected to the bus 69.

On the other hand, as shown in FIG. 15, the server 12 of the present exemplary embodiment is different from the server 12 (see FIG. 2) of the first exemplary embodiment in that it has a communication unit 37.

Similar to the wireless communication unit 38 of the first exemplary embodiment, the communication unit 37 has a function of communicating with the student terminal 16 by wireless communication. Further, the communication unit 37 has a function of communicating with the teacher terminal 14, and has a communication function (at least one of wireless communication or wired communication) corresponding to the teacher terminal 14. The communication unit 37 is connected to the bus 39.

As shown in FIG. 15, the server 12 of this exemplary embodiment further stores an attendance status display control process program 33B, which will be described in detail later, in the ROM 32.

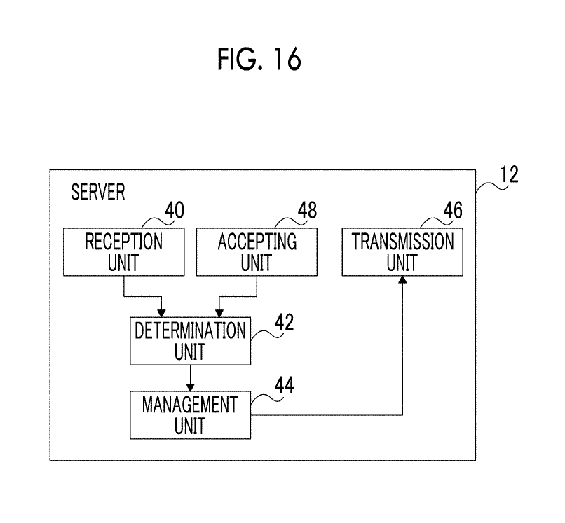

The server 12 of the present exemplary embodiment is different from the server 12 (see FIG. 3) of the first exemplary embodiment in that it further includes an accepting unit 48 as shown in the functional block diagram of FIG. 16. The accepting unit 48 has a function of accepting an output instruction for displaying information on the attendance status, from the teacher terminal 14 and the student terminal 16, by the communication unit 37 described above.

The management unit 44 of the present exemplary embodiment further has a function of acquiring information corresponding to the output instruction accepted by the accepting unit 48 from various types of information such as the course transcript data 112 stored in the memory 36, and generating necessary information in accordance with the content of the output instruction. Further, the transmission unit 46 has a function of transmitting various types of information to the external device by the above-described communication unit 37.

Next, the operation of the attendance status management system 10 of the present exemplary embodiment will be described. Similar to the attendance status management system 10 of the first exemplary embodiment, in the attendance status management system 10 of the present exemplary embodiment, the teacher terminal 14 executes the teacher terminal process (see FIG. 12), the student terminal 16 executes the student terminal process (see FIG. 13), and the server 12 executes the attendance status management process (see FIG. 14).

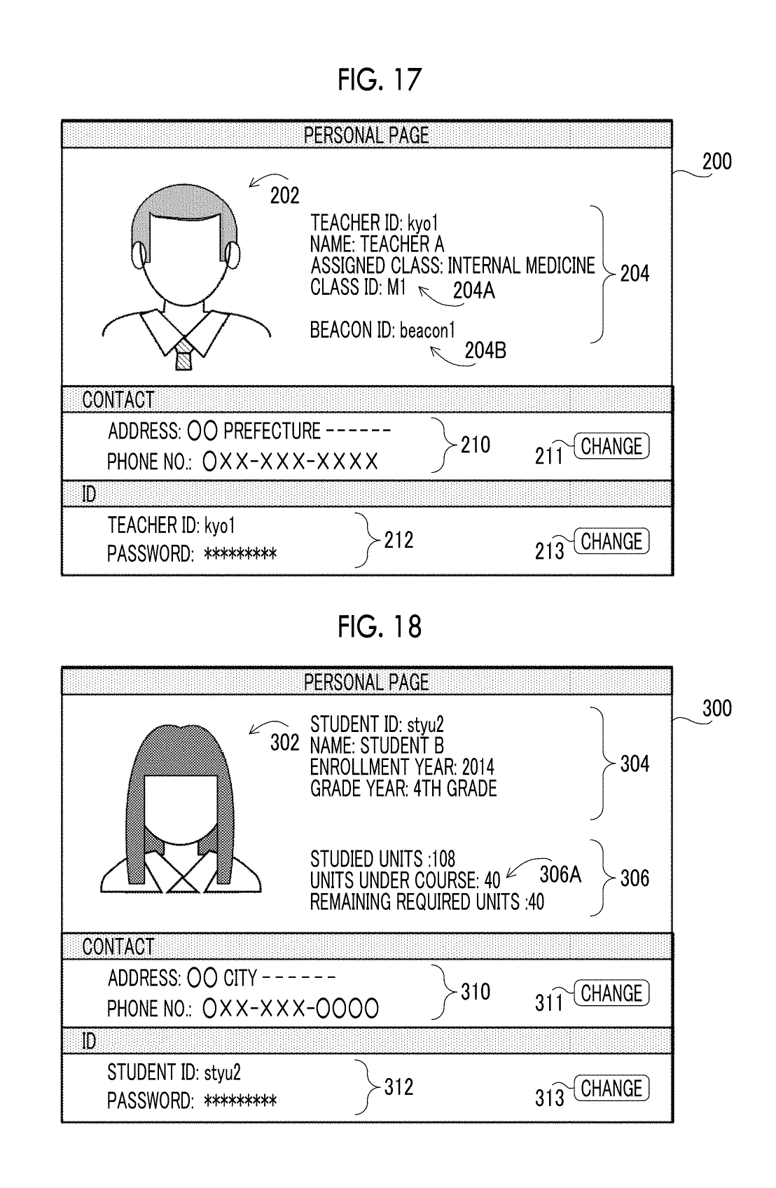

Further, in the present exemplary embodiment, as described above, the accepting unit 48 of the server 12 accepts an output instruction from the teacher terminal 14 and the student terminal 16. There is no particular limitation on the method by which the teacher gives the above-described output instruction in the teacher terminal 14 and the method by which the student gives the above-described output instruction in the student terminal 16. As an example, in the present exemplary embodiment, in a case where the password is input by the operation unit 64 of the teacher terminal 14 and the teacher is authenticated, a personal page 200 displaying the personal information of the teacher shown as an example in FIG. 17 is displayed on the display 66, an output instruction is given from the personal page 200 by using the operation unit 64.

As shown in FIG. 17, on the personal page 200 of the present exemplary embodiment, as the personal information of a specific teacher, teacher information 204 including a photograph 202 of the teacher individual, a teacher ID, a name, an assigned class, an ID (class ID) 204A of the assigned class, and a beacon ID 204B of the teacher terminal 14 owned by the teacher is displayed. In addition, as shown in FIG. 17, on the personal page 200, contact information 210 of the teacher, a change button 211 to be designated in a case of changing the contact information 210, teacher ID information 212 including the teacher ID and the password of the teacher, and a change button 213 to be designated in a case of changing the password are further displayed.

Further, in a case where the password is input by the operation unit 82 of the student terminal 16 and the student is authenticated, a personal page 300 displaying the personal information of the student shown as an example in FIG. 18 is displayed on the display 84, an output instruction is given from the personal page 300 by using the operation unit 82.

As shown in FIG. 18, a student individual photo 302 and student information 304 including a student ID, a name, an enrollment year, and a grade year are displayed as personal information of a specific student in the personal page 300 of the present exemplary embodiment. In addition, as shown in FIG. 18, on the personal page 300, course status information 306 including the number of each of units that a student has completed, units that the student is taking, and remaining required units is displayed. In addition, as shown in FIG. 18, on the personal page 300, contact information 310 of the student, a change button 311 designated in a case of changing the contact information 310, student ID information 312 including the student ID of the student and the password, and a change button 313 designated in a case of changing the password is further displayed.

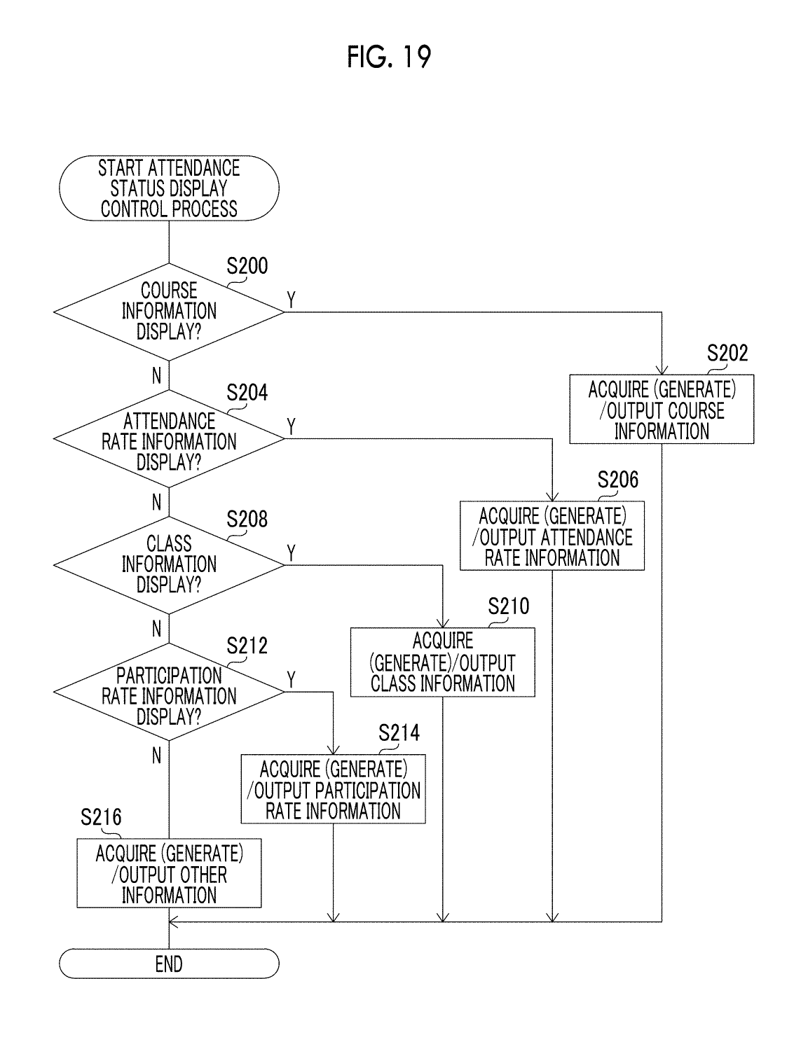

In a case where the server 12 receives the output instruction, the CPU 30 executes the attendance status display control process program 33B stored in the ROM 32. By executing the attendance status display control process program 33B stored in the ROM 32, the CPU 30 functions as the management unit 44 shown in FIG. 16, and the attendance status display control process shown in FIG. 19 is executed. FIG. 19 is a flowchart showing an example of a flow of the attendance status display control process of the present exemplary embodiment.

In step S200, the management unit 44 determines whether or not the received output instruction is a request for information for displaying course information. In the present exemplary embodiment, the course information includes information such as units that a specific student has completed, the attendance rate of the units that the student is taking, and the like. For example, in a case where any piece of the course status information 306 such as units 306A that the student is taking on the personal page 300 is designated by the operation unit 82, an output instruction for requesting information for displaying the course information on the display 84 is output from the student terminal 16 to the server 12.

In a case where the output instruction is a request for information for displaying course information, an affirmative determination is made in step S200, and the process proceeds to step S202.

In step S202, the management unit 44 acquires information for displaying course information from the memory 36 in response to a request for output instruction, outputs the information, and then ends the attendance status display control process. FIG. 21 shows an example of course information 120 displayed on the display 84. It goes without saying that the specific contents and display format of the displayed course information 120 are not particularly limited.

The course information 120 shown in FIG. 21 is associated with the class IDs of the class that the student has completed and the class that the student is taking, a class name, the acquired number of units, the assigned teacher, the attendance rate (first half and second half), and evaluation by the teacher (first half and second half).

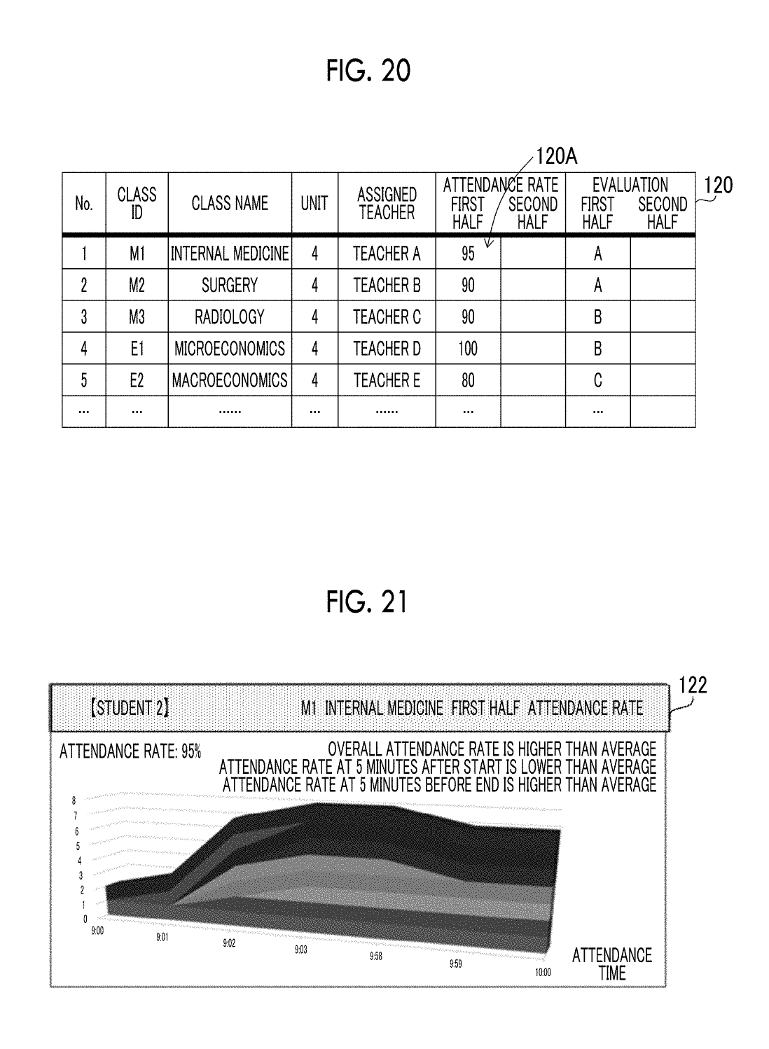

Therefore, the management unit 44 of the present exemplary embodiment acquires the information necessary for the course information 120, from the class master data 102, the student master data 106, the course master data 108, and the course transcript data 112, which are stored in the memory 36. Based on the acquired information, the management unit 44 generates and outputs attendance information to be displayed in the form of the course information 120 shown in FIG. 20. In addition, the management unit 44 outputs the acquired information itself, and the apparatus (here, the student terminal 16) that has received the information may generate attendance information to be displayed in the form of the course information 120 shown in FIG. 20, based on the received information.

On the other hand, in a case where the output instruction is not a request for information for displaying the course information, a negative determination is made in step S200, and the process proceeds to step S204.

In step S204, the management unit 44 determines whether or not the received output instruction is a request for information for displaying attendance rate information. In the present exemplary embodiment, the attendance rate information includes information indicating the details of the attendance rate of a specific student for a specific class. For example, in a case where the attendance rate 120A of the course information 120 is designated by the operation unit 82, an output instruction for requesting information for displaying the attendance rate information on the display 84 is output from the student terminal 16 to the server 12.

In a case where the output instruction is a request for information for displaying attendance rate information, an affirmative determination is made in step S204, and the process proceeds to step S206.

In step S206, the management unit 44 acquires information for displaying attendance rate information from the memory 36 in response to a request for output instruction, outputs the information, and then ends the attendance status display control process. FIG. 21 shows an example of the attendance rate information 122 displayed on the display 84. It goes without saying that the specific contents and display format of the attendance rate information 122 to be displayed are not particularly limited. The attendance rate information 122 of the present exemplary embodiment is an example of information indicating the attendance status of the owner to be managed in the present disclosure at every predetermined time.

The attendance rate information 122 shown in FIG. 21 is a stacked-up drawing stacking up the stay status during the time period in which the class corresponding to the attendance rate 120A of the course information 120 is executed. As an example, FIG. 21 shows the state of stacking up the stay status of the student at 9:00 to 10:00 at which the class is performed, for eight classes. According to the attendance rate information 122 shown in FIG. 21, it is understood that the student was staying in the classroom to be attended, for all classes, at 9:03 to 9:58. Further, at 9:00 in which the class is started, it is understood that the student was staying in the classroom only in two classes. Further, at 9:59 before the end of the class, it is understood that the student was staying in the classroom only in the six classes.

The management unit 44 of the present exemplary embodiment acquires necessary information for the attendance rate information 122 from the course transcript data 112 stored in the memory 36. Based on the acquired information, the management unit 44 generates and outputs attendance information to be displayed in the form of attendance rate information 122 shown in FIG. 21. In addition, the management unit 44 outputs the acquired information itself, and the apparatus (here, the student terminal 16) that has received the information may generate attendance information to be displayed in the form of the attendance rate information 122 shown in FIG. 21, based on the received information.

On the other hand, in a case where the output instruction is not a request for information for displaying the attendance rate information, a negative determination is made in step S204, and the process proceeds to step S208.

In step S208, the management unit 44 determines whether or not the received output instruction is a request for information for displaying class information. In the present exemplary embodiment, the class information includes information indicating, for a specific teacher, a participation rate of a class that the teacher is in charge of. The participation rate refers to the number of students who actually take a class which is defined by the course master data 108 with respect to the number of students who are required to take the class.

For example, in a case where the class ID 204A of the personal page 200 is designated by the operation unit 82, an output instruction for requesting information for displaying the tree information on the display 66 is output from the teacher terminal 14 to the server 12.

In a case where the output instruction is a request for information for displaying class information, an affirmative determination is made in step S208, and the process proceeds to step S210.

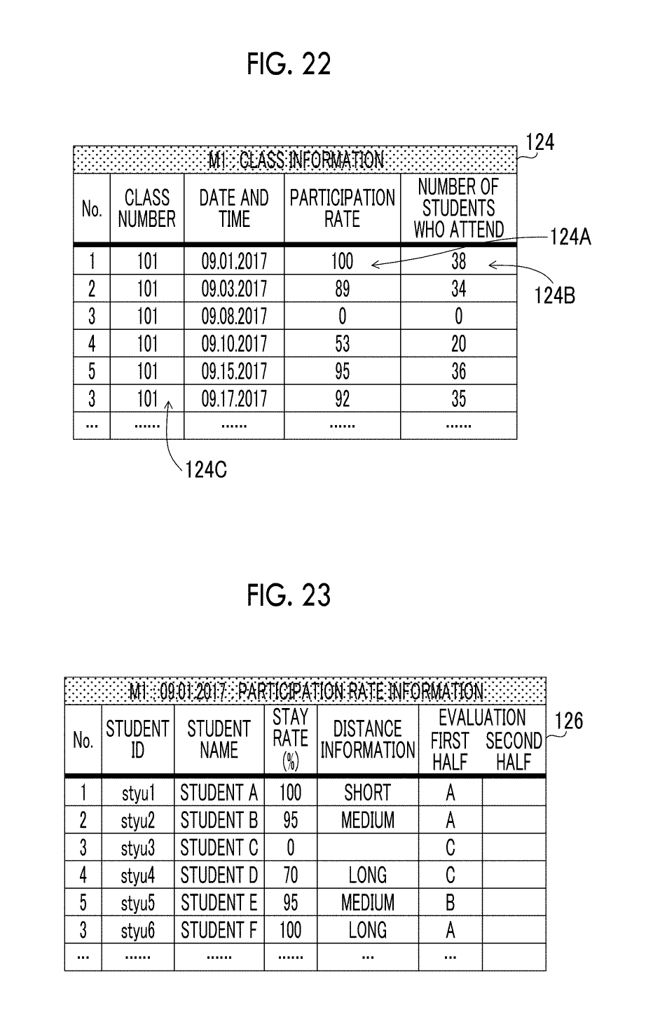

In step S210, the management unit 44 acquires information for displaying class information from the memory 36 in response to a request for output instruction, outputs the information, and then ends the attendance status display control process. FIG. 22 shows an example of class information 124 displayed on the display 84. In the class information 124 shown in FIG. 22, the number of students who attend the class and the participation rate are associated with each other in a case where a specific class is implemented. It goes without saying that the specific contents and display format of the displayed class information 124 are not particularly limited.

The management unit 44 of the present exemplary embodiment acquires necessary information for the attendance rate information 122 from the course transcript data 112 stored in the memory 36. Based on the acquired information, the management unit 44 generates and outputs attendance information to be displayed in the form of the class information 124 shown in FIG. 22. In addition, the management unit 44 outputs the acquired information itself, and the apparatus (here, the teacher terminal 14) that has received the information may generate attendance information to be displayed in the form of the class information 124 shown in FIG. 22, based on the received information.

On the other hand, in a case where the output instruction is not a request for information for displaying the class information, a negative determination is made in step S208, and the process proceeds to step S212.

In step S212, the management unit 44 determines whether or not the received output instruction is a request for information for displaying participation rate information. In the present exemplary embodiment, the participation rate information includes the stay rate of each student to take a class that a specific teacher is in charge of, and distance information.

For example, in a case where the participation rate 124A of the class information 124 or the number 124B of attendees is designated by the operation unit 82, an output instruction for requesting information for displaying the participation rate information on the display 84 is output from the teacher terminal 14 to the server 12.

In a case where the output instruction is a request for information for displaying participation rate information, an affirmative determination is made in step S212, and the process proceeds to step S214.

In step S214, the management unit 44 acquires information for displaying participation rate information from the memory 36 in response to a request for output instruction, outputs the information, and then ends the attendance status display control process. FIG. 23 shows an example of participation rate information 126 displayed on the display 84. The participation rate information 126 shown in FIG. 23 indicates the participation rate per class, and the student ID, the student name, the stay rate, the distance information, and the evaluation of the student are associated with each other. It goes without saying that the specific contents and display format of the participation rate information 126 to be displayed are not particularly limited.

The management unit 44 of the present exemplary embodiment acquires necessary information for the attendance rate information 122 from the student master data 106 and the course transcript data 112 stored in the memory 36. Based on the acquired information, the management unit 44 generates and outputs attendance information to be displayed in the form of participation rate information 126 shown in FIG. 23. In addition, the management unit 44 outputs the acquired information itself, and the apparatus (here, the teacher terminal 14) that has received the information may generate attendance information to be displayed in the form of the participation rate information 126 shown in FIG. 23, based on the received information.

As described above, in the present exemplary embodiment, distance information indicating the distance between the teacher terminal 14 and the student terminal 16 is included in the participation rate information 126 to be displayed, so for example, the teacher can use the distance information for evaluation.

On the other hand, in a case where the output instruction is not a request for information for displaying the participation rate information, a negative determination is made in step S212, and the process proceeds to step S216.

In step S216, the management unit 44 acquires information for displaying other information designated by the received output instruction from the memory 36, outputs the information, and then ends the attendance status display control process. For example, in a case where the class information 124 is displayed on the display 84 and the room number 124C in the class information 124 is designated by the operation unit 82, classroom master data 100 may be displayed on the display 84.

As described above, in the present exemplary embodiment, the accepting unit 48 accepts an output instruction of attendance information for displaying the attendance status or an output instruction of information required for generating attendance information related to the attendance status. The management unit 44 acquires information corresponding to the received output instruction, from the information indicating the attendance status such as the course transcript data 112 accumulated in the memory 36. Then, the management unit 44 generates attendance information based on the acquired information, and outputs it to the teacher terminal 14 or the student terminal 16. Alternatively, the management unit 44 outputs the acquired information to the teacher terminal 14 or the student terminal 16.

The attendance status may be displayed while the class to be attended are being implemented. In this case, the teacher is able to recognize the students staying in the classroom, in real time during class. Further, at this time, since a position where a student is staying is known by displaying the distance information as well, the teacher can check whether the student is actually present or absent, so it becomes easy to detect false or find fraud by the student.

As described above, the server 12 of each of the above-described exemplary embodiments includes a determination unit 42 that determines whether the position of the student terminal 16 is a position within a predetermined distance from the teacher terminal 14 and determines whether or not the student terminal 16 is located in a classroom which is an area which is an attendance target, and a management unit 44 that manages the attendance status of the student who is the owner of the student terminal 16 based on the determination result of the determination unit 42.

It goes without saying that the technology of the present disclosure is not limited to each of the above-described exemplary embodiments. For example, in each of the above-described exemplary embodiments, the server 12 receives the beacon ID, the teacher terminal position information, the student terminal position information, the user identification information, and the distance information from the student terminal 16, but some or all of these types of information may be received from the teacher terminal 14.

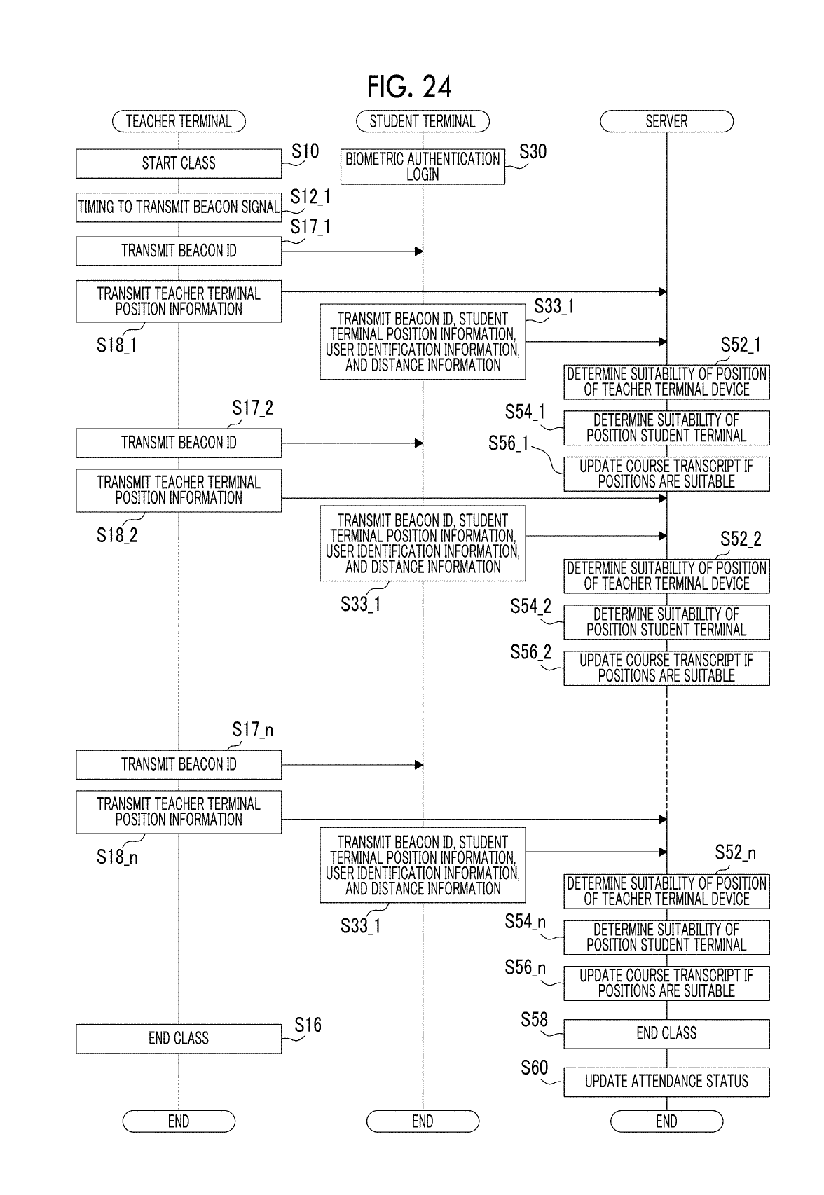

For example, the teacher terminal 14 may transmit teacher terminal position information to the server 12. FIG. 24 shows a time chart showing an example of the operations of the server 12, the teacher terminal 14, and the student terminal 16 in this case. The teacher terminal 14 executes the steps S17_1, S17_2, . . . , S17_n, and the steps S18_1, S18_2, . . . , S18_n, instead of the steps S14_1, S14_2, . . . , S14_n in the time chart shown in FIG. 11 in the first exemplary embodiment. In steps S17_1, S17_2, . . . , S17_n, the teacher terminal 14 transmits only the beacon signal. Further, in steps S18_1, S18_2, . . . , S18_n, the teacher terminal 14 transmits the teacher terminal position information to the server 12. Meanwhile, in response to the beacon signal, the student terminal 16 executes the steps S33_1, S33_2, . . . , S33_n, instead of the steps S32_1, S32_2, . . . , S32_n in the time chart shown in FIG. 11 in the first exemplary embodiment. That is, the student terminal 16 transmits the beacon ID, the student terminal position information, the user identification information, and the distance information to the server 12 in the steps S33_1, S33_2, . . . , S33_n.

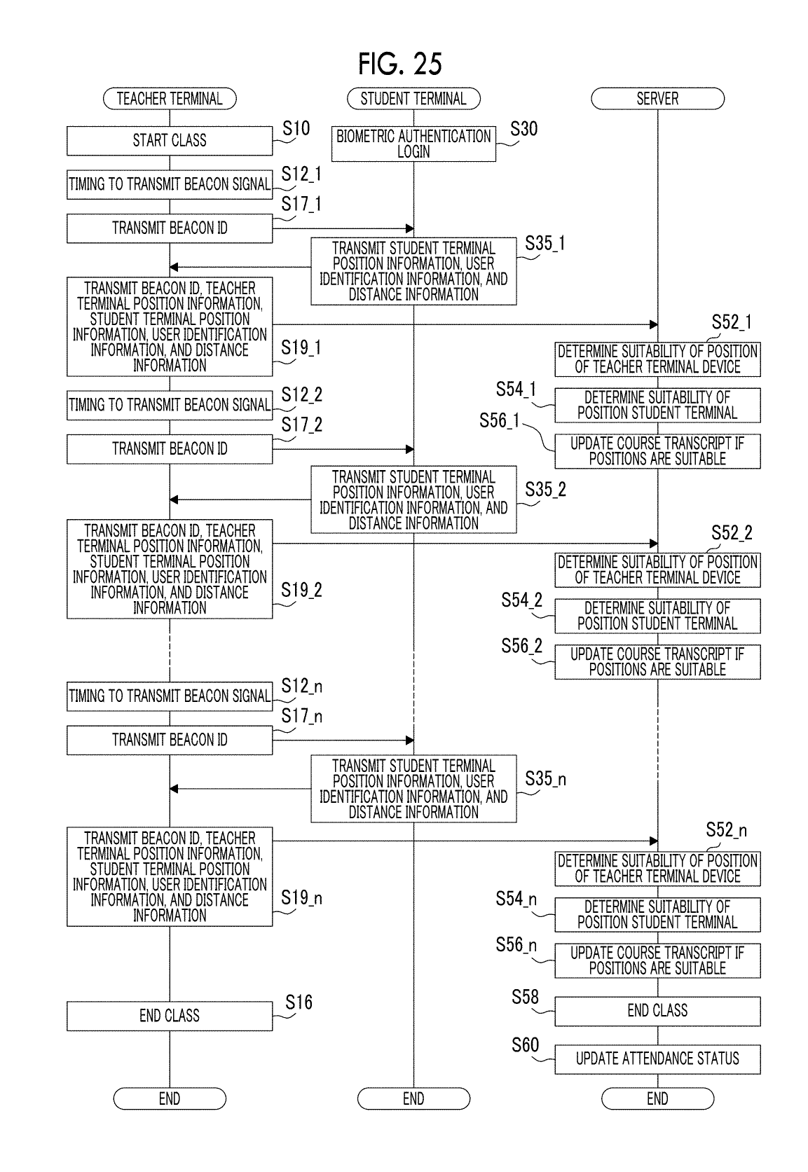

Further, for example, the teacher terminal 14 may transmit the beacon ID, the teacher terminal position information, the student terminal position information, the user identification information, and the distance information to the server 12. A time chart showing an example of the operations of the server 12, the teacher terminal 14, and the student terminal 16 in this case is shown in FIG. 25. The teacher terminal 14 executes the steps S171, S172, . . . , S17_n and the steps S19_1, S19_2, . . . , S19_n, instead of the steps S14_1, S14_2, . . . , S14_n in the time chart shown in FIG. 11 in the first exemplary embodiment. As described above, in steps S17_1, S17_2, . . . , S17_n, the teacher terminal 14 transmits only the beacon signal. In the case shown in FIG. 25, in response to the beacon signal, the student terminal 16 executes the steps S35_1, S35_2, . . . , S35_n, instead of the steps S32_1, S32_2, . . . , S32_n in the time chart shown in FIG. 11 in the first exemplary embodiment. That is, the student terminal 16 transmits the beacon ID, the student terminal position information, the user identification information, and the distance information to the teacher terminal 14 in the steps S35_1, S35_2, . . . , S35_n.

The teacher terminal 14 that has received these types of information transmits the beacon ID, the teacher terminal position information, the student terminal position information, the user identification information, and the distance information to the server 12 in the steps S19_1, S19_2, S19_n.

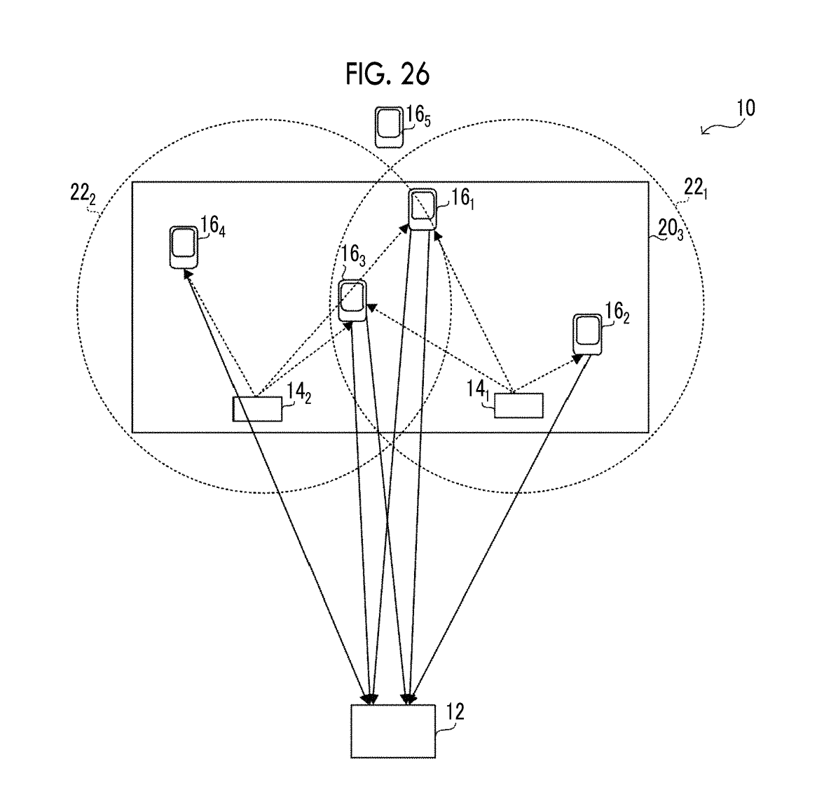

In each of the above exemplary embodiments, the case where the beacon area 22 is larger than the classroom 20 has been described. However, in a case where the beacon area 22 is smaller than the classroom 20, the classroom 20 may be included in the area including the beacon area 22 of each teacher terminal 14 by the plural teacher terminals 14. For example, in the example shown in FIG. 26, since the classroom 20₃ is included in the area including the beacon area 22₁ of the teacher terminal 14₁ and the beacon area 22₂ of the teacher terminal 14₂, it is possible to manage the attendance status of the class performed in the classroom 20₃ by the teacher terminal 14₁ and the teacher terminal 14₂.

In each of the above-described exemplary embodiments, the beacon signal is transmitted from the teacher terminal 14 plural times during the class and the attendance status of the student who is the management target is managed, but the number of times to transmit the beacon signal is not particularly limited.

In each of the above-described exemplary embodiments, classes have been exemplified as attendance targets, but it goes without saying that the attendance target is not limited to classes, but may be lectures, seminars, courses, conferences, various events, or the like.

In addition, the GPS information is not limited to the above exemplary embodiments, and information in the height direction may be included. In this case, for example, it is possible to more accurately manage the attendance status in the first floor classroom and the second floor classroom of which the latitudes and longitudes are similar.

In each of the above-described exemplary embodiments, the case where the information on the short distance, the medium distance, and the long distance obtained from the intensity of the beacon signal is used as distance information has been described, but the distance information is not limited thereto. For example, a specific distance derived from the position of the main terminal device and the position of the sub terminal device may be used as the distance information, or information obtained by classifying the derived specific distance into the short distance, the medium distance, the long distance, or the like as described above by using a threshold may be used as a distance status.

In each of the above-described exemplary embodiments, the case where a teacher carries the teacher terminal 14 and the teacher terminal 14 is brought into a classroom to conduct a class has been described, the teacher terminal 14 may be placed (fixed) in each classroom. In this case, in the classroom master data 100, the classroom number of each classroom and the teacher terminal 14 fixed in the classroom may be associated with each other.

In each of the above-described exemplary embodiments, an aspect in which the teacher terminal processing program 53 is stored (installed) in advance in the ROM 52 in the teacher terminal 14, the distance information is stored (installed) in advance in the ROM 72 in the student terminal 16, and various programs are stored (installed) in advance in the ROM 32 in the server 12 has been described, but the present invention is not limited thereto. These programs may be provided in a form recorded on a recording medium such as a CD-ROM, a Digital Versatile Disk Read Only Memory (DVD-ROM), and a Universal Serial Bus (USB) memory. Further, various programs may be downloaded from an external device through a network.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An attendance status management apparatus comprising:
a determination unit that determines whether or not a position of a sub terminal device is a position within a predetermined distance from a main terminal device, and determines whether or not a position of the sub terminal device is a position within an area which is an attendance target; and
a management unit that manages an attendance status of an owner of the sub terminal device, based on a determination result of the determination unit.

2. The attendance status management apparatus according to claim 1,
wherein the management unit manages the attendance status of the owner as attendance, in a case where the position of the sub terminal device determined by the determination unit is the position within the predetermined distance from the main terminal device, and the position of the sub terminal device is the position within the area which is the attendance target.

3. The attendance status management apparatus according to claim 1,
wherein the management unit manages the attendance status of the owner as absence, in a case where the position of the sub terminal device determined by the determination unit is at least one of the position outside the predetermined distance from the main terminal device or the position outside the area which is the attendance target.

4. The attendance status management apparatus according to claim 2,
wherein the management unit manages the attendance status of the owner as absence, in a case where the position of the sub terminal device determined by the determination unit is at least one of the position outside the predetermined distance from the main terminal device or the position outside the area which is the attendance target.

5. The attendance status management apparatus according to claim 1, further comprising:
a reception unit that receives main terminal position information indicating a position of the main terminal device and sub terminal position information indicating a position of the sub terminal device,
wherein the determination unit performs the determination, based on the main terminal position information and the sub terminal position information received by the reception unit.

6. The attendance status management apparatus according to claim 5,
wherein the reception unit receives the main terminal position information from the main terminal device or the sub terminal device, and receives the sub terminal position information from the main terminal device or the sub terminal device.

7. The attendance status management apparatus according to claim 5,
wherein the management unit manages the attendance status of the owner as attendance, only in a case where the position of the main terminal device according to the main terminal position information is a position within the area which is the attendance target.

8. The attendance status management apparatus according to claim 1, further comprising:
a reception unit that receives distance information indicating a distance between the main terminal device and the sub terminal device and sub terminal position information indicating a position of the sub terminal device,
wherein the determination unit performs the determination, based on the distance information and the sub terminal position information received by the reception unit.

9. The attendance status management apparatus according to claim 8,
wherein the reception unit receives the distance information from the main terminal device or the sub terminal device, and receives the sub terminal position information from the main terminal device or the sub terminal device.

10. The attendance status management apparatus according to claim 8,
wherein the reception unit further receives main terminal position information indicating a position of the main terminal device, and
wherein the management unit manages the attendance status of the owner as attendance, only in a case where the position of the main terminal device according to the main terminal position information is a position within the area which is the attendance target.

11. The attendance status management apparatus according to claim 5,
wherein the reception unit receives the sub terminal position information obtained from the sub terminal device whose owner is authenticated by biometric authentication.

12. The attendance status management apparatus according to claim 1,
wherein the main terminal device transmits a beacon signal to which a transmission target is attached, to the sub terminal device, and
wherein the predetermined distance is a distance reached by the beacon signal.

13. The attendance status management apparatus according to claim 1,
wherein the determination unit performs the determination for each attendance target where the attendance status of the owner of the sub terminal device is managed, and
wherein the management unit accumulates information indicating an attendance status of the owner to be managed, for each attendance target.

14. The attendance status management apparatus according to claim 13, further comprising:
an accepting unit that accepts an output instruction of attendance information for displaying attendance status,
wherein the management unit generates the attendance information accepted by the accepting unit, based on information acquired from the accumulated information representing the attendance status and outputs the attendance information to an external device.

15. The attendance status management apparatus according to claim 13, further comprising:
an accepting unit that accepts an output instruction of information required for generating attendance information on an attendance status,
wherein the management unit acquires the information required for generating the attendance information to be accepted by the accepting unit, from the accumulated information representing the attendance status and outputs the acquired information to an external device.

16. The attendance status management apparatus according to claim 14,
wherein the attendance information includes information on a distance between the main terminal device and the sub terminal device.

17. The attendance status management apparatus according to claim 14,
wherein the management unit includes information indicating an attendance status of the owner to be managed, at every predetermined time, with respect to the attendance target.

18. An attendance status management apparatus comprising:
a management unit that manages an attendance status of an owner of a sub terminal device, based on whether or not a position of the sub terminal device is a position within a predetermined distance from a main terminal device and whether or not the position of the sub terminal device is a position within an area which is an attendance target.

19. An attendance status management method comprising:
determining whether or not the position of the sub terminal device is the position within the predetermined distance from the main terminal device and is the position within an area which is an attendance target, and
managing the attendance status of the owner of the sub terminal device, based on a determination result.

20. A non-transitory computer readable medium storing an attendance status management program causing a computer to function as:
the determination unit and the management unit of the attendance status management apparatus according to claim 1.
